(19) United States
(12) Patent Application Publication
(10) Pub. No.: US 2025/0093842 A1
(43) Pub. Date: Mar. 20, 2025

(54) INFORMATION GENERATION DEVICE AND COMPUTER-READABLE STORAGE MEDIUM

(71) Applicant: Fanuc Corporation, Minamitsuru-gun, Yamanashi (JP)

(72) Inventors: Yuuki SUGITA, Minamitsuru-gun, Yamanashi (JP); Nobuaki AIZAWA, Minamitsuru-gun, Yamanashi (JP)

(73) Assignee: Fanuc Corporation, Minamitsuru-gun, Yamanashi (JP)

(21) Appl. No.: 18/727,929

(22) PCT Filed: Jan. 21, 2022
(86) PCT No.: PCT/JP2022/002291

§ 371 Date: Jul. 10, 2024

(51) Int. Cl. G05B 19/4068

(52) U.S. Cl. CPC G05B 19/4068; G05B 2219/35287

(57) ABSTRACT

An information generation device includes an image acquisition unit that acquires an image indicating the state of an industrial machine; a dictionary storage unit that stores a dictionary in which state information indicating the control state of a control device for controlling the industrial machine is associated with drawing information for visually rendering the control state; a display mode storage unit that stores, for each type of state information, the display mode of the drawing information associated with the state information; a state information acquisition unit that acquires state information; a generation unit that generates display information for displaying the drawing information associated with the state information, in the display mode associated with the type of the state information; an association unit that associates the display information with the image acquired by the image acquisition unit; and an output unit that outputs the associated display information and the image.

### CROSS REFERENCE TO RELATED APPLICATIONS

This is the U.S. National Phase application of PCT/JP2022/002291, filed Jan. 21, 2022 the disclosures of this application being incorporated herein by reference in its entirety for all purposes.

### FIELD OF THE INVENTION

The present disclosure relates to an information generation device and a computer readable storage medium.

### BACKGROUND OF THE INVENTION

Conventionally, systems to display various signals indicating control states of an industrial machine on a viewing screen are known (Patent Literature 1). In such systems, an input/output timings of multiple types of signals are displayed on the viewing screen.

### PATENT LITERATURE

Patent Literature 1: Japanese Patent Application Laid-Open No. 2020-175534

### SUMMARY OF THE INVENTION

In the conventional system, however, even with display of various signals on the viewing screen, it is difficult to make the operator understand what kind of control state the control device is in. For example, the operator is required to have much experience to understand what kind of operation is being performed in an industrial machine by looking at the states of various signals displayed on the viewing screen. That is, it is difficult for an inexperienced operator to understand the operation being performed in the industrial machine even by looking at the states of various signals.

Therefore, in the technical field of industrial machines, there is a demand for an information generation device and a computer readable storage medium that enable the operator to easily understand the control state of a control device.

An information generation device includes: an image acquisition unit that acquires an image indicating a state of an industrial machine; a dictionary storage unit that stores a dictionary in which state information indicating a control state of a control device that controls the industrial machine is associated with drawing information for visually drawing the control state; a display mode storage unit that stores a display mode of the drawing information associated with the state information for each type of the state information; a state information acquisition unit that acquires the state information; a generation unit that generates display information for displaying the drawing information associated with the state information in the dictionary in the display mode associated with the type of the state information stored in the display mode storage unit, based on the state information acquired by the state information acquisition unit; an associating unit that associates the display information generated by the generation unit with the image acquired by the image acquisition unit; and an output unit that outputs the display information and the image associated with each other by the associating unit.

A computer-readable storage medium stores an instruction that causes a computer to perform: acquiring an image indicating a state of an industrial machine; storing a dictionary in which state information indicating a control state of a control device that controls the industrial machine is associated with drawing information for visually drawing the control state; storing a display mode of the drawing information associated with the state information for each type of the state information; acquiring the state information; generating display information for displaying the drawing information associated with the state information in the dictionary in the display mode associated with the type of the stored state information, based on the acquired state information; associating the generated display information with the acquired image; and outputting the display information and the image associated with each other.

According to one aspect of the present disclosure, it is possible to make the operator easily understand the control state of a control device.

### BRIEF DESCRIPTION OF DRAWINGS

FIG. 1 is a block diagram illustrating an example of a hardware configuration of a machine tool.

FIG. 2 is a block diagram illustrating an example of functions of an information generation device.

FIG. 3 is a diagram illustrating an example of information registered in a dictionary.

FIG. 4 is a diagram illustrating an example of a display mode stored in a display mode storage unit.

FIG. 5 is a diagram illustrating an example of an image and display information displayed on a display screen.

FIG. 6 is a diagram illustrating an example of a display mode stored in the display mode storage unit.

FIG. 7 is a diagram illustrating an example of an image and display information displayed on the display screen.

FIG. 8 is a diagram illustrating an example of a graphic display.

FIG. 9 is a diagram illustrating an example of a graphic display.

FIG. 10 is a diagram illustrating an example of an image and display information displayed on the display screen.

FIG. 11 is a flowchart illustrating an example of a process performed in the information generation device.

### DETAILED DESCRIPTION OF EMBODIMENTS OF THE INVENTION

An information generation device according to an embodiment of the present disclosure will be described below with reference to the drawings. Note that not all combinations of features described in the following embodiments are necessarily required to solve the problem. Further, more detailed description than is needed may be omitted. Further, the following description of the embodiment and the drawings are provided for those skilled in the art to fully understand the present disclosure and are not intended to limit the scope of the claims.

The information generation device is implemented on a control device that controls an industrial machine, for example. The information generation device may be implemented on a server, a personal computer (PC), or a mobile tablet device connected to the control device via a wired connection or a wireless connection.

The industrial machine includes a machine tool, an injection molding machine, a wire electric discharge machine, and an industrial robot. The machine tool is, for example, a lathe, a machining center, a drilling center, and a combined machine. The control device is, for example, a numerical control device that controls an industrial machine. The following description will be provided for an embodiment in which the information generation device is implemented on a control device that controls a machine tool.

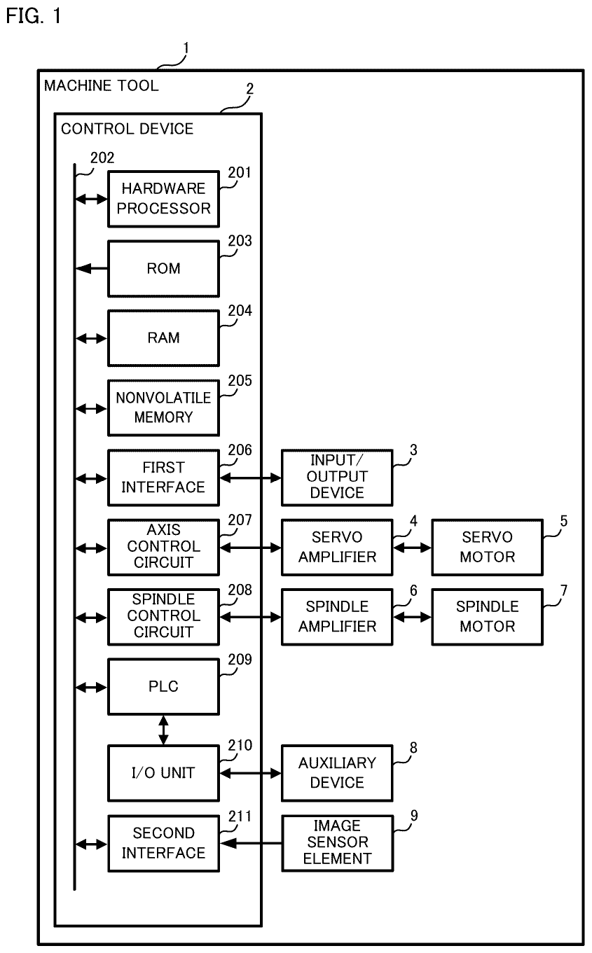

FIG. 1 is a block diagram illustrating an example of a hardware configuration of a machine tool including a control device.

A machine tool 1 includes a control device 2, an input/output device 3, a servo amplifier 4, a servo motor 5, a spindle amplifier 6, a spindle motor 7, an auxiliary device 8, and an image sensor element 9.

The control device 2 is a device that controls the entire machine tool 1. The control device 2 includes a hardware processor 201, a bus 202, a read only memory (ROM) 203, a random access memory (RAM) 204, and a nonvolatile memory 205.

The hardware processor 201 is a processor that controls the entire control device 2 in accordance with a system program. The hardware processor 201 reads the system program stored in the ROM 203 via the bus 202 and performs various processes based on the system program. The hardware processor 201 controls the servo motor 5 and the spindle motor 7 based on a machining program. The hardware processor 201 is, for example, a central processing unit (CPU) or an electronic circuit.

For example, the hardware processor 201 analyzes a machining program and outputs control instructions to the servo motor 5 and the spindle motor 7 in each control cycle.

The bus 202 is a communication path connecting respective hardware components within the control device 2 to each other. These hardware components within the control device 2 transfer data via the bus 202.

The ROM 203 is a storage device that stores the system program for controlling the entire control device 2 or the like. The ROM 203 may store an information generating program. The information generating program is a program to be executed in the information generation device. The ROM 203 is a computer-readable storage medium.

The RAM 204 is a storage device that temporarily stores various data. The RAM 204 functions as a work area where the hardware processor 201 processes various data.

The nonvolatile memory 205 is a storage device that holds data even in a state where the machine tool 1 is powered off and no power is supplied to the control device 2. The nonvolatile memory 205 stores a machining program and various parameters, for example. The nonvolatile memory 205 is a computer-readable storage medium. The nonvolatile memory 205 is formed of a memory backed up by a battery or a solid state drive (SSD), for example.

The control device 2 further includes a first interface 206, an axis control circuit 207, a spindle control circuit 208, a programmable logic controller (PLC) 209, an I/O unit 210, and a second interface 211.

The first interface 206 connects the bus 202 and the input/output device 3 to each other. The first interface 206 transmits various data processed by the hardware processor 201 to the input/output device 3, for example.

The input/output device 3 is a device that receives various data via the first interface 206 and displays the various data. Further, the input/output device 3 accepts input of various data and transmits the various data to the hardware processor 201, for example, via the first interface 206.

The input/output device 3 is a touch panel, for example. When the input/output device 3 is a touch panel, the input/output device 3 is a capacitive touch panel, for example. Note that the touch panel may be other types of touch panels without being limited to the capacitive type. The input/output device 3 is installed to an operation panel (not illustrated) in which the control device 2 is stored.

The axis control circuit 207 is a circuit that controls the servo motor 5. In response to receiving a control instruction from the hardware processor 201, the axis control circuit 207 outputs an instruction for driving the servo motor 5 to the servo amplifier 4. For example, the axis control circuit 207 transmits a torque command for controlling the torque of the servo motor 5 to the servo amplifier 4.

In response to receiving an instruction from the axis control circuit 207, the servo amplifier 4 supplies current to the servo motor 5.

The servo motor 5 is driven in response to being supplied with current from the servo amplifier 4. The servo motor 5 is connected to a ball screw that drives a tool rest, for example. In response to the servo motor 5 being driven, the structure of the machine tool 1 such as a tool rest moves in each control axis direction. The servo motor 5 has a built-in encoder (not illustrated) that detects the position of the control axis and the feed rate. Position feedback information and rate feedback information indicating the position of the control axis and the feed rate of the control axis, respectively, which are detected by the encoder, are fed back to the axis control circuit 207. Accordingly, the axis control circuit 207 performs feedback control of the control axis.

The spindle control circuit 208 is a circuit for controlling the spindle motor 7. In response to receiving a control instruction from the hardware processor 201, the spindle control circuit 208 transmits an instruction for driving the spindle motor 7 to the spindle amplifier 6. For example, the spindle control circuit 208 transmits a spindle rate command for controlling a rotational rate of the spindle motor 7 to the spindle amplifier 6.

In response to receiving an instruction from the spindle control circuit 208, the spindle amplifier 6 supplies current to the spindle motor 7.

The spindle motor 7 is driven in response to being supplied with current from the spindle amplifier 6. The spindle motor 7 is connected to the spindle and rotates the spindle.

The PLC 209 is a device that executes a ladder program to control the auxiliary device 8. The PLC 209 transmits an instruction to the auxiliary device 8 via the I/O unit 210.

The I/O unit 210 is an interface connecting the PLC 209 and the auxiliary device 8 to each other. The I/O unit 210 transmits an instruction received from the PLC 209 to the auxiliary device 8.

The auxiliary device 8 is a device installed to the machine tool 1 and configured to perform an auxiliary operation in the machine tool 1. The auxiliary device 8 operates based on an instruction received from the I/O unit 210. The auxiliary device 8 may be a device installed in the periphery of the machine tool 1. The auxiliary device 8 is, for example, a tool exchanger, a cutting liquid injector, or an open/closure door drive device.

The second interface 211 connects the bus 202 and the image sensor element 9 to each other. The second interface 211 transmits image data taken by the image sensor element 9 to the hardware processor 201.

The image sensor element 9 is a component that converts light emitted from an object and input through a lens into digital image data and outputs the digital image data. The image sensor element 9 is also referred to as an image sensor. For example, the image sensor element 9 is mounted on a camera.

Next, functions of the information generation device will be described.

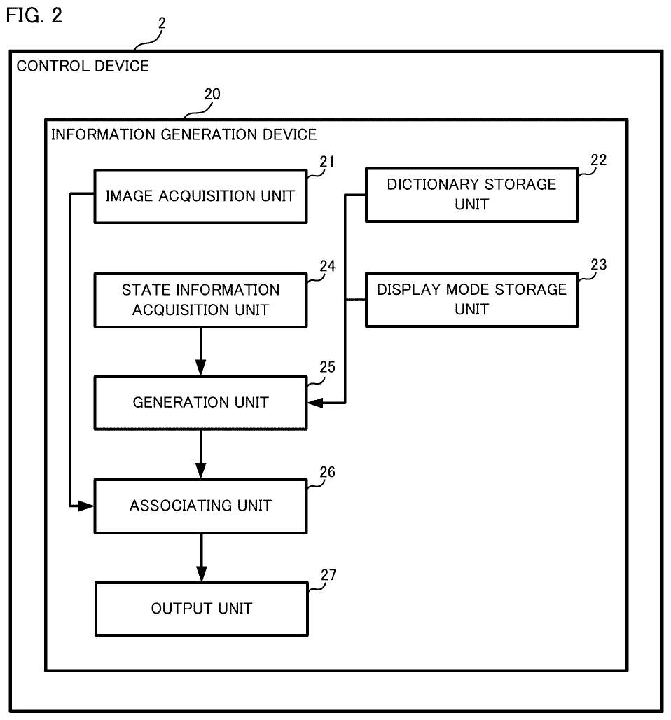

FIG. 2 is a block diagram illustrating an example of the functions of the information generation device implemented on the control device 2. The information generation device 20 includes an image acquisition unit 21, a dictionary storage unit 22, a display mode storage unit 23, a state information acquisition unit 24, a generation unit 25, an associating unit 26, and an output unit 27.

The image acquisition unit 21, the state information acquisition unit 24, the generation unit 25, the associating unit 26, and the output unit 27 are implemented when the hardware processor 201 performs computation processing by using a system program and an information generating program stored in the ROM 203 and various data stored in the nonvolatile memory 205, for example. The dictionary storage unit 22 and the display mode storage unit 23 are implemented with various data being stored in the RAM 204 or the nonvolatile memory 205.

The image acquisition unit 21 acquires an image indicating the state of the machine tool 1. For example, the image indicating the state of the machine tool 1 is an image of the machine tool 1 taken by the image sensor element 9. The image includes at least any one of a static image and a moving image. For example, the image acquisition unit 21 acquires an image of the machine tool 1 from a camera that takes the external appearance of the machine tool 1. For example, once execution of a machining program is started in the machine tool 1, the image sensor element 9 starts taking an image, and the image acquisition unit 21 starts acquiring the image. The image acquisition unit 21 may acquire image data from a camera that takes an image of a machining region of a workpiece. The image acquisition unit 21 sequentially acquires images taken at a predetermined frame rate.

The image indicating the state of the machine tool 1 may be an image displayed on the display screen of the input/output device 3. That is, the image acquired by the image acquisition unit 21 may be a capture image in which an image displayed on the display screen of the input/output device 3 is captured. The image acquisition unit 21 acquires an image displayed on the display screen of the input/output device 3 from a capture device (not illustrated). For example, once execution of the machining program is started in the machine tool 1, the image acquisition unit 21 starts acquiring an image displayed on the display screen of the input/output device 3.

The dictionary storage unit 22 stores a dictionary in which state information indicating the control state of the control device 2 that controls an industrial machine is associated with drawing information used for visually drawing the control state. The dictionary can also be said as a table in which state information and drawing information are associated with each other. The control state includes at least any one of the state of a signal, the state of a macro variable, and the state of a shared variable in the control device 2. That is, the state information includes at least any one of information indicating the state of a signal, information indicating the state of a macro variable, and information indicating the state of a shared variable.

The state of a signal indicates a value indicated by the signal. For example, when the signal changes between “0” and “1”, the value indicated by the signal will be “0” or “1”. The state of a signal includes the state of an output signal output from the control device 2 and the state of an input signal input to the control device 2. Further, the state of a signal includes the state of a signal based on a machining program instruction and the state of a signal based on a sequence program instruction.

The output signal output from the control device 2 includes, for example, a signal to provide an instruction for opening an open/closure door and a signal to start injection of a coolant.

The input signal input to the control device 2 includes, for example, a contact signal indicating contact of a touch probe with a target object and a temperature abnormal signal from a temperature sensor.

The state of a signal based on a machining program instruction is the state of a signal that changes due to execution of an instruction designated by the machining program. For example, the instruction designated by the machining program is a tool exchange instruction “M6”.

The state of a signal based on a sequence program instruction is the state of a signal that changes due to execution of the sequence program. For example, the signal that changes due to execution of a sequence program is a specific function in-progress signal.

The state of a macro variable is a value of the macro variable. For example, the macro variable is expressed by a character string consisting of “#” and a four-digit number. For example, a numerical value indicating a measurement result from a measuring device is input as the macro variable.

The state of a shared variable is a value of the shared variable. The shared variable means a memory area accessible from both the system program and the embedded program. For example, the shared variable is expressed by a character string such as “cnc_prog_no”. A program number is input as such a shared variable.

The state information may include information indicating the edition state of a machining program, information indicating the edition state of a sequence program, information indicating the setup state of a parameter, and information indicating the setup state of an offset.

The information indicating the edition state of a machining program is information indicating that the machining program has been edited. The information indicating the edition state of a sequence program is information indicating that the sequence program has been edited.

The information indicating the setup state of a parameter is a numerical value set as the parameter. For example, the parameter is a feed rate parameter. For example, a numerical value such as “100” is set as the feed rate parameter.

The information indicating the setup state of an offset is a numerical value set as the offset. The offset is a numerical value for correcting a tool length and a tool diameter.

The drawing information for visually drawing the control state is information for making the operator visually understand the control state of the control device 2. The drawing information is text information and graphic information.

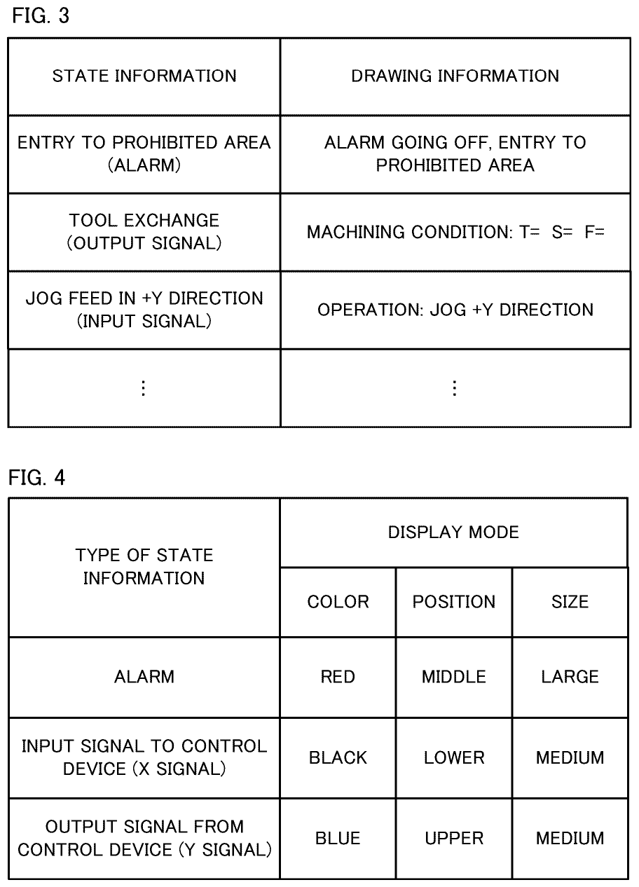

FIG. 3 is a diagram illustrating an example of information registered in the dictionary. In the dictionary, the state information indicating input of a signal indicating that, for example, a person or a tool spindle or a table of the machine tool 1 has entered the inside of the machine tool 1 or entered an entry prohibited area around the machine tool 1 is associated with the drawing information “ALARM GOING OFF, ENTRY TO PROHIBITED AREA”. Further, the state information indicating that a signal to provide an instruction for execution of tool exchange has been output is associated with the drawing information “MACHINING CONDITION: T=S=F=”. Further, state information indicating the state information indicating that a signal to JOG-feed a control axis in the plus direction on the Y-axis has been input is associated with the drawing information “OPERATION: JOG+Y DIRECTION”.

The display mode storage unit 23 stores display modes of drawing information associated with state information for each type of state information. The type of state information can also be said to be the attribute of the state information.

When the state information is information indicating the state of a signal, the type of state information includes an alarm, an input signal to the control device 2, and an output signal from the control device 2, for example. That is, multiple types of state information acquired in the control device 2 include a signal classified as an alarm, a signal classified as an input signal to the control device 2, and a signal classified as an output signal from the control device 2. Further, a signal classified as an alarm, a signal classified as an input signal to the control device 2, and a signal classified as an output signal from the control device 2 may include multiple types of signals, respectively.

The display mode includes at least any one of a color, a size, a display position, a display time, an animation format, and a drawing method.

The color is information defining hue, saturation, and brightness of drawing information. Note that, when the saturation and the brightness of information to be displayed on the display screen in the control device 2 are predefined, the display mode storage unit 23 is not necessarily required to store the saturation and the brightness as the display mode. That is, the hue may be stored as a color.

The size is information defining the size of drawing information when the drawing information is displayed on the display screen. For example, the size is defined as “large”, “medium”, and “small” indicating a relative size. The size may be information indicating the absolute size of drawing information.

The display position is information defining the display position of drawing information when the drawing information is displayed on the display screen. For example, the display position is defined by “upper”, “middle”, and “lower” indicating a relative position on the display screen for the drawing information.

The display time is information defining a display time from start to end of display of drawing information. The display time may be expressed by the number of frames of images acquired by the image acquisition unit 21.

The animation format is information defining animation when drawing information is displayed on the display screen. The animation includes blinking display, fade-in display, and fade-out display. Note that the fade-in display refers to display that causes drawing information to gradually appear. The fade-out display refers to display that causes drawing information to gradually disappear.

The drawing method includes subtitle display, graph display, and chart display. The subtitle display is display of drawing information with a character string. The graph display is display of drawing information with a graph. The chart display is display of drawing information with a graphic or a table.

FIG. 4 is a diagram illustrating an example of a display mode stored by the display mode storage unit 23. The display mode storage unit 23 stores a color “RED”, a position “MIDDLE”, and a size “LARGE” in association with “ALARM”. That is, the display mode storage unit 23 stores that drawing information indicating state information classified as an alarm is displayed in red, at the middle position in the display screen, and with a large text or graphic.

Further, the display mode storage unit 23 stores a color “BLACK”, a position “LOWER”, and a size “MEDIUM” in association with “INPUT SIGNAL TO CONTROL DEVICE (X SIGNAL)”. That is, the display mode storage unit 23 stores that drawing information indicating the state information classified as an input signal to the control device 2 is displayed in black, in the lower part in the display screen, and with a medium-sized text or graphic.

Further, the display mode storage unit 23 stores a color “BLUE”, a position “UPPER”, and a size “MEDIUM” in association with “OUTPUT SIGNAL FROM CONTROL DEVICE (Y SIGNAL)”. That is, the display mode storage unit 23 stores that drawing information indicating the state information classified as an output signal to the control device 2 is displayed in blue, in the upper part in the display screen, and with a medium-sized text or graphic.

The state information acquisition unit 24 acquires state information indicating the control state of the control device 2 from the control device 2. For example, the state information acquisition unit 24 acquires state information at the time that the state information changes. The time when the state information changes refers to the time when the value of a signal changes from “0” to “1”, for example. Further, the time when the state information changes refers to the time when the value of a macro variable or a shared variable changes.

Based on the state information acquired by the state information acquisition unit 24, the generation unit 25 generates display information configured to cause drawing information associated with state information in the dictionary to be displayed in a display mode associated with the type of state information stored in the display mode storage unit 23.

For example, when the state information acquisition unit 24 has acquired a signal indicating an alarm, the generation unit 25 generates display information configured to cause a character string indicating the alarm to be displayed in a color “RED”, at a position “MIDDLE”, and with the size “LARGE”. Further, when the state information acquisition unit 24 has acquired an input signal to the control device 2, the generation unit 25 generates display information configured to cause a character string indicating the input signal to be displayed in a color “BLACK”, at a position “LOWER”, and with a size “MEDIUM”. Further, when the state information acquisition unit 24 has acquired an output signal from the control device 2, the generation unit 25 generates display information configured to cause a character string indicating the output signal to be displayed in a color “BLUE”, at a position “UPPER”, and with a size “MEDIUM”.

The associating unit 26 associates display information generated by the generation unit 25 with an image acquired by the image acquisition unit 21. Herein, the image acquired by the image acquisition unit 21 is a single frame acquired at the same timing as the timing of acquisition of state information by the state information acquisition unit 24. Herein, “the same” does not necessarily require to be the same in a strict sense and may tolerate a deviation within a range from several milliseconds to several seconds.

The output unit 27 outputs an image acquired by the image acquisition unit 21. Further, the output unit 27 outputs display information associated with an image by the associating unit 26. For example, the output unit 27 outputs display information and an image to the input/output device 3.

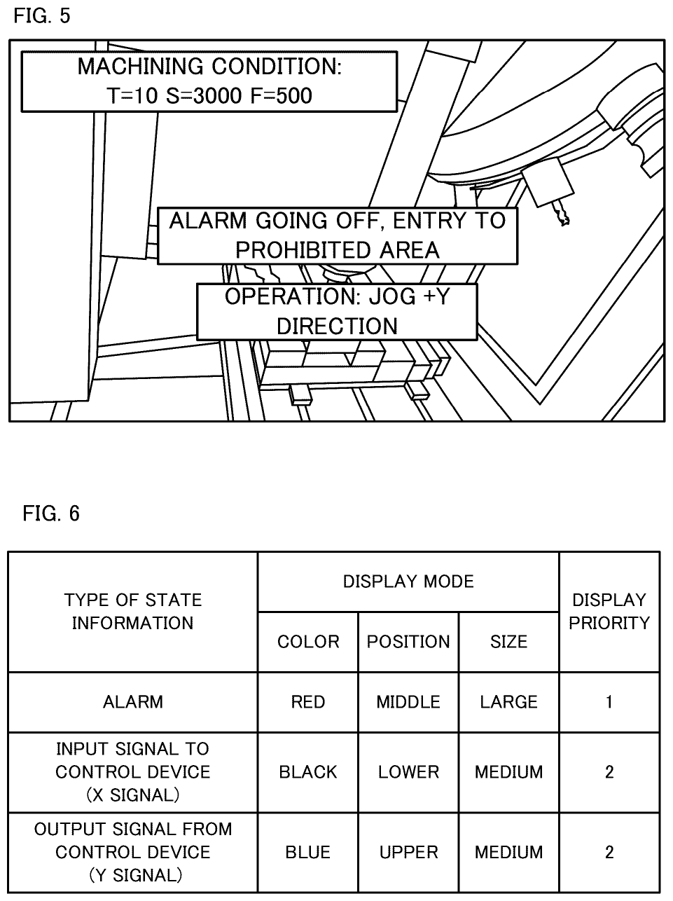

FIG. 5 is a diagram illustrating an example of display information and an image displayed on the display screen of the input/output device 3. The example illustrated in FIG. 5 indicates display information displayed on the display screen when the state information acquisition unit 24 has acquired an output signal indicating execution of tool exchange, an alarm signal indicating entry to an entry prohibited area, and an input signal to JOG-feed a control axis in the plus direction on the Y axis during a predetermined period.

In the display screen, the character string “ALARM GOING OFF, ENTRY TO PROHIBITED AREA” reporting an alarm is displayed in the middle. For example, the character string is displayed within a rectangular display region. The display region is filled in red. For example, the character string is displayed in white.

Further, in response to execution of tool exchange as a trigger, the character string “MACHINING CONDITION: T=10 S=3000 F=500” indicating machining conditions is displayed in the upper part in the display screen. For example, the character string is displayed within a rectangular display region. The display region is filled in blue. For example, the character string is displayed in white. Note that, in this character string, “MACHINING CONDITION: T=S=F=” is information registered in the dictionary, and the numerical value “10” indicating a tool number, the numerical value “3000” indicating the rotational rate of the spindle, and the numerical value “500” indicating the feed rate are displayed, respectively, when values in a predetermined memory area of the control device 2 are loaded.

Further, in the display screen, the character string “OPERATION: JOG+Y DIRECTION” indicating JOG feed of the control axis in the plus direction on the Y-axis is displayed in the lower part. For example, the character string is displayed within a rectangular display region. The display region is filled in black. For example, the character string is displayed in white.

In the example illustrated in FIG. 5, display information related to an alarm is displayed in a relatively highlighted manner, and this enables the operator to easily recognize an important event occurring in the control device 2.

FIG. 6 is a diagram illustrating another example of a display mode stored in the display mode storage unit 23. FIG. 6 represents an example in which the display mode storage unit 23 further stores display priority in addition to the display mode illustrated in FIG. 4 in association with types of state information. The display priority is a numerical value indicating the degree of how much priority is given to the display of drawing information associated with state information. When the display mode storage unit 23 stores display priority, a predetermined number of pieces of display information are displayed based on the display priority. For example, in the display screen, it is predefined that four pieces of display information at the maximum are displayed. For example, the display priority is prioritized for display in ascending order of the numerical value.

The display mode storage unit 23 stores display priority “1” in association with “ALARM”. Further, the display mode storage unit 23 stores display priority “2” in association with “INPUT SIGNAL TO CONTROL DEVICE (X SIGNAL)”. Further, the display mode storage unit 23 stores display priority “2” in association with “OUTPUT SIGNAL FROM CONTROL DEVICE (Y SIGNAL)”. In such a case, the information indicating an alarm is displayed in the highest priority.

Based on the state information acquired by the state information acquisition unit 24, the generation unit 25 generates display information configured to cause drawing information associated with state information in the dictionary to be displayed in a display mode associated with the type of the state information stored in the display mode storage unit 23. In a state where multiple types of display information are displayed on the display screen, when the state information acquisition unit 24 has further acquired state information, the generation unit 25 generates display information based on the display priority.

For example, in a state where the number of pieces of display information to be displayed on the display screen is predefined to “four” and three types of display information are displayed on the display screen as illustrated in FIG. 5, the state information acquisition unit 24 acquires an input signal to the control device 2 to designate a mode change. In such a case, the generation unit 25 generates display information to display the character string “OPERATION: MODE CHANGE BUTTON” on the display screen based on the display mode stored in the display mode storage unit 23. The display information generated by the generation unit 25 is associated with an image by the associating unit 26.

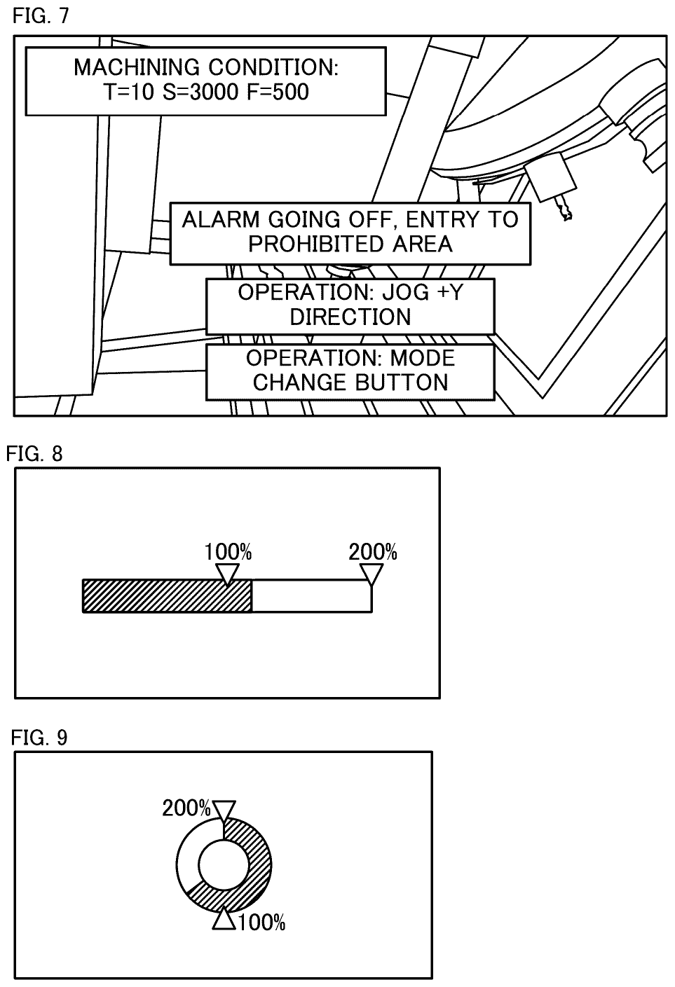

FIG. 7 is a diagram illustrating an image and display information associated by the associating unit 26 and output by the output unit 27. In a state where four types of display information are displayed on the display screen as illustrated in FIG. 7, when the state information acquisition unit 24 has further acquired an input signal to the control device 2, for example, an input signal indicating key entry, the generation unit 25 does not newly generate display information. This is because the display priority for an input signal to the control device 2 is “2” and four pieces of display information are already displayed on the display screen.

Further, in a state where four types of display information are displayed on the display screen as illustrated in FIG. 7, when the state information acquisition unit 24 has further acquired a signal indicating an alarm, the generation unit 25 newly generates display information indicating the alarm. This is because the display priority of an alarm is set to “1”. In such a case, display information having lower display priority displayed on the display screen is deleted at the timing the drawing information indicating the alarm is displayed.

FIG. 8 and FIG. 9 are diagrams illustrating examples in which graph display is set as a display mode. In FIG. 8, speed override is indicated by a bar chart. In FIG. 9, speed override is indicated by a pie chart. In such a case, in the dictionary, numerical values indicating override values are stored in association with state information indicating speed override, for example.

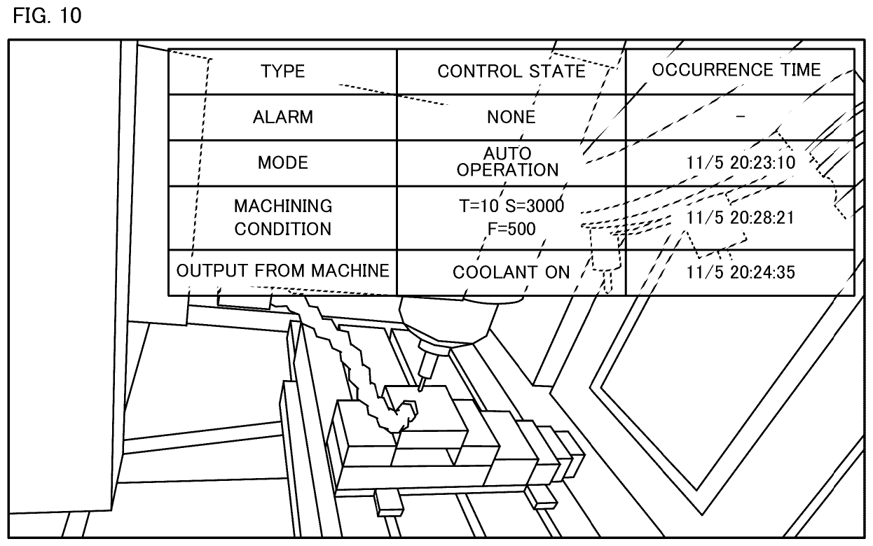

FIG. 10 is a diagram illustrating an example in which a table is set as a display mode. In such a case, in the display mode storage unit 23, a table is associated as a display mode with all the types of state information. When the display mode is a table, information related to date and time of acquisition of each state information may be displayed in the table.

Next, the process performed in the information generation device 20 will be described.

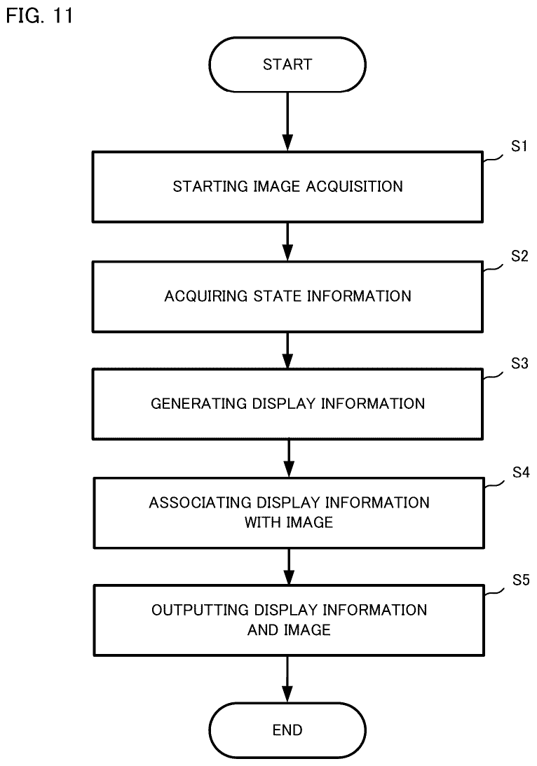

FIG. 11 is a flowchart illustrating an example of the process performed in the information generation device 20. For example, once execution of a machining program is started in the machine tool 1, the image acquisition unit 21 starts acquisition of an image indicating the state of the machine tool 1 (step S1).

Next, the state information acquisition unit 24 acquires state information indicating the state of the control device 2 that controls the machine tool 1 (step S2). As described above, the state information acquisition unit 24 acquires state information when the state information changes in the control device 2, for example.

Next, based on the state information, the generation unit 25 generates display information configured to cause drawing information associated with the state information in the dictionary to be displayed in a display mode associated with the type of state information stored in the display mode storage unit 23 (step S3).

Next, the associating unit 26 associates the display information generated by the generation unit 25 with the image acquired by the image acquisition unit 21 (step S4).

Next, the output unit 27 outputs the display information and the image associated by the associating unit 26 (step S5) and ends the process.

As described above, the information generation device 20 includes: the image acquisition unit 21 that acquires an image indicating a state of an industrial machine; the dictionary storage unit 22 that stores a dictionary in which state information indicating a control state of the control device 2 that controls the industrial machine is associated with drawing information for visually drawing the control state; the display mode storage unit 23 that stores a display mode of the drawing information associated with the state information for each type of the state information; the state information acquisition unit 24 that acquires the state information; the generation unit 25 that generates display information for displaying the drawing information associated with the state information in the dictionary in the display mode associated with the type of the state information stored in the display mode storage unit 23, based on the state information acquired by the state information acquisition unit 24; the associating unit 26 that associates the display information generated by the generation unit 25 with the image acquired by the image acquisition unit 21; and the output unit 27 that outputs the display information and the image associated with each other by the associating unit 26.

Therefore, the information generation device 20 enables the operator to easily understand the control state of the control device 2. Specifically, the information generation device 20 displays what kind of phenomenon is occurring in the control device 2 by using a text, a graph, a table, or the like. Thus, the information generation device 20 enables the operator to easily understand what kind of phenomenon is occurring in the control device 2. Further, when a plurality of phenomena is occurring, information of high importance can be accurately recognized.

Further, the state information includes at least any one of information indicating the state of a signal, information indicating the state of a macro variable, information indicating the state of a shared variable, information indicating the setup state of a parameter, and information indicating the setup state of an offset. Further, the state information may include at least any one of information indicating the edition state of a machining program and information indicating the edition state of a sequence program. Therefore, the information generation device 20 enables the operator to easily understand various states in the control device 2.

Further, the display mode includes at least any one of a color, a size, a display position, a display time, an animation format, and a drawing method. Therefore, the information generation device 20 can display the display information in a display manner in accordance with the control state of the control device 2. As a result, the information generation device 20 enables the operator to easily understand various states in the control device 2.

Further, the display mode storage unit 23 further stores state information and display priority of the state information in association with each other. Therefore, the information generation device 20 can prioritize and display the display information related to an important control state.

The display mode storage unit 23 may further store the display mode in association with at least any one of the levels of a value indicated by the state information and the change rate of the value indicated by the state information.

For example, when the value of a signal is 1, the display mode storage unit 23 may store a display mode for displaying drawing information configured to cause a black character string to be indicated in a display region filled in white. Alternatively, when the value of the signal is 0, the display mode storage unit 23 may store a display mode for displaying drawing information configured to cause a white character string to be indicated in a display region filled in black.

Further, the display mode storage unit 23 may store a display mode for displaying drawing information in yellow when the value of the input signal indicating the override value is less than 100%. The display mode storage unit 23 may store a display mode for displaying drawing information in green when the value of an input signal indicating the override value is 100%. The display mode storage unit 23 may store a display mode for displaying drawing information in red when the value of the input signal indicating the override value is greater than 100%.

Further, when measurement of a workpiece is performed, the display mode storage unit 23 may store a display mode for displaying the measurement value in black when the value of a macro variable indicating the difference from the previous measurement value is less than 1 [mm]. Further, the display mode storage unit 23 may store a display mode for displaying the measurement value in red when the value of the macro variable indicating the difference from the previous measurement value is greater than or equal to 1 [mm].

The display mode storage unit 23 may further store information indicating whether the drawing information is displayed or hidden in association with a manner of a change of the state information. For example, the display mode storage unit 23 may store information for displaying a character string when the value of a signal changes from 0 to 1 and hiding the character string when the value of the signal changes from 1 to 0.

In the embodiment described above, it has been described that the state information includes at least any one of information indicating the state of a signal, information indicating the state of a macro variable, and information indicating the state of a shared variable. However, the state information may include other information. The state information may include information indicating that a program has been edited, information indicating a value of a parameter and a tool offset, information indicating that an instruction of a machining program has been executed, and information indicating that an instruction of a sequence program has been executed.

For example, when state information indicating that a machining program has been edited is acquired by the state information acquisition unit 24, drawing information indicating that a program has been edited may be displayed on the display screen. In such a case, the drawing information is stored in the dictionary in association with the state information indicating that the program has been edited.

Further, when state information indicating that the value of a feed rate parameter has been changed to 200 is acquired by the state information acquisition unit 24, drawing information indicating that the value of the feed rate parameter has been changed to 200 may be displayed on the display screen. In such a case, the drawing information is stored in the dictionary in association with the state information indicating that the value of the rate parameter has been changed to 200.

Further, when state information indicating that the value of a tool offset has been changed to 110 [mm] is acquired by the state information acquisition unit 24, drawing information indicating that the value of the tool offset has been changed to 110 [mm] may be displayed on the display screen. In such a case, the drawing information is stored in the dictionary in association with the state information indicating that the value of the tool offset has been changed to 110 [mm].

Further, when state information indicating that a predetermined instruction designated in a machining program has been executed is acquired by the state information acquisition unit 24, drawing information indicating that the predetermined instruction has been executed may be displayed on the display screen. In such a case, the drawing information is stored in the dictionary in association with the state information indicating that the predetermined instruction of the machining program has been executed.

Further, when state information indicating that a predetermined instruction designated in a sequence program has been executed is acquired by the state information acquisition unit 24, drawing information indicating that the predetermined instruction has been executed may be displayed on the display screen. In such a case, the drawing information is stored in the dictionary in association with the state information indicating that the predetermined instruction of the sequence program has been executed.

The present disclosure is not limited to the embodiment described above and can be changed as appropriate within the scope not departing from the spirit. In the present disclosure, modification of any component of the embodiment or omission of any component of the embodiment is possible.

### LIST OF REFERENCE SYMBOLS

1 machine tool
2 control device
20 information generation device
21 image acquisition unit
22 dictionary storage unit
23 display mode storage unit
24 state information acquisition unit
25 generation unit
26 associating unit
27 output unit
201 hardware processor
202 bus
203 ROM
204 RAM
205 nonvolatile memory
206 first interface
207 axis control circuit
208 spindle control circuit
209 PLC
210 I/O unit
211 second interface
3 input/output device
4 servo amplifier
5 servo motor
6 spindle amplifier
7 spindle motor
8 auxiliary device
9 image sensor element

1. An information generation device comprising:
an image acquisition unit that acquires an image indicating a state of an industrial machine;
a dictionary storage unit that stores a dictionary in which state information indicating a control state of a control device that controls the industrial machine is associated with drawing information for visually drawing the control state;
a display mode storage unit that stores a display mode of the drawing information associated with the state information for each type of the state information;
a state information acquisition unit that acquires the state information;
a generation unit that generates display information for displaying the drawing information associated with the state information in the dictionary in the display mode associated with the type of the state information stored in the display mode storage unit, based on the state information acquired by the state information acquisition unit;
an associating unit that associates the display information generated by the generation unit with the image acquired by the image acquisition unit; and
an output unit that outputs the display information and the image associated with each other by the associating unit.

2. The information generation device according to claim 1, wherein the state information includes at least any one of information indicating a state of a signal, information indicating a state of a macro variable, information indicating a state of a shared variable, information indicating a setup state of a parameter, and information indicating a setup state of an offset.

3. The information generation device according to claim 1, wherein the display mode includes at least any one of a color, a size, a display position, a display time, an animation format, and a drawing method.

4. The information generation device according to claim 2, wherein the display mode includes at least any one of a color, a size, a display position, a display time, an animation format, and a drawing method.

5. The information generation device according to claim 1, wherein the display mode storage unit further stores the display mode in association with at least any one of a level of a value indicated by the state information and a change rate of the value indicated by the state information.

6. The information generation device according to claim 1, wherein the display mode storage unit further stores display priority in association with the type of the state information.

7. The information generation device according to claim 1, wherein the display mode storage unit further stores information indicating whether the drawing information is displayed or hidden in association with a manner of a change of the state information.

8. The information generation device according to claim 1, wherein the state information includes at least any one of information indicating an edition state of a machining program and information indicating an edition state of a sequence program.

9. A computer-readable storage medium storing an instruction that causes a computer to perform:
acquiring an image indicating a state of an industrial machine;
storing a dictionary in which state information indicating a control state of a control device that controls the industrial machine is associated with drawing information for visually drawing the control state;
storing a display mode of the drawing information associated with the state information for each type of the state information;
acquiring the state information;
generating display information for displaying the drawing information associated with the state information in the dictionary to be displayed in the display mode associated with the type of the stored state information, based on the acquired state information;
associating the generated display information with the acquired image; and
outputting the display information and the image associated with each other.
